(19) United States
(12) Patent Application Publication
(10) Pub. No.: US 2010/0285187 A1
(43) Pub. Date: Nov. 11, 2010

(54) APPARATUS AND METHODS FOR CUTTING INDIVIDUAL PIECES FROM A FOOD EXTRUDATE

(76) Inventors: James N. Weinstein, Maple Grove, MN (US); Susan M. Hayes Jacobson, Edina, MN (US); Terry G. Reishus, Eagan, MN (US); Cara J. Sekerak, Lakeville, MN (US); Michael Viland, Eden Praire, MN (US); Laura Burant, Hudson, WI (US)

Correspondence Address: GENERAL MILLS, INC., P.O. BOX 1113, MINNEAPOLIS, MN, 55440, US

(21) Appl. No.: 12/437,850

(22) Filed: May 8, 2009

(51) Int. Cl. A23L 1/025; A23P 1/12

(52) U.S. Cl. 426/238; 425/174.2

(57) ABSTRACT

A cutting mechanism (40) in a preferred form of an ultrasonically vibrating titanium knife (42) is moved in a cutting path parallel to but without physical contact with the die face (18) of an extrusion die (16) with its faces (46, 48) at a minor acute angle relative to the die face (18). The die face (18) is at an acute angle to the conveyance direction of a conveyance mechanism (12) defining a preferred form of a takeaway device. The cutting mechanism (40) is moved in a return path from the completion of the cutting path in the extrudate direction away from the die face (18), away from the conveyance mechanism (12), and then towards the die face (18) to the initiation of the cutting path. The cutting mechanism (40) is spaced from and does not physically contact the conveyance mechanism (12) at all times in the cutting path so that the individual piece is cut from the extrudate in mid-air.

### BACKGROUND

The present invention generally relates to apparatus and methods for cutting food extrudates into individual pieces or slices, particularly relates to apparatus and methods for cutting food extrudates which change in shape with the slightest touch at ambient temperatures, and specifically relates to apparatus and methods for cutting food extrudates which would adhere to a conventional metal knife if cut thereby.

A conventional manner of producing many types of food products is that the food substances are mixed and otherwise processed including, but not limited to, pre-cooking in batches and then extruded as an extrudate out an extrusion die, with the extrudate after extrusion being cut to form individual pieces. Such extrudates could be in the form of a single homogenous food substance or could be in the form of one or more food substances arranged in a pattern. Additionally, extrudates can also contain a multicolored extrusion pattern or picture formed of one or more food substances. Furthermore, the extrusion die and thus the extrudate exiting therefrom and the individual pieces cut therefrom can be of any desired shape representing an item of interest.

Due to the nature of many food substances, such food substances tend to be very sticky and are very prone to deformation during cutting. Once cut, the individual pieces are also prone to additional deformation due to movement, falling onto a surface, or from mechanical handling. Thus, reduction in the handling of the individual pieces and maintenance of the design and shape of the individual pieces are of major concerns. Deformation of the individual pieces during cutting will not only deform the overall shape of the individual pieces, but can potentially make the internal pattern unrecognizable. A conventional manner of minimizing such deformation is extruding the extrudate upon a conveyor which passes through a chiller to reduce the extrudate temperature before cutting occurs. U.S. Pat. No. 6,309,686 is a typical procedure for cutting extruded sticky items. U.S. Pat. No. 6,561,235 is another example of prior attempts to fulfill these concerns when taking cut products and attempting to convey them downstream of the extrusion cutting device An alternative method of cutting extrudates away from the face of a die is to use a guillotine style blade cutter. With the use of this type of guillotine cutter, the sharp surface of the blade must ultimately land on a hard surface to help separate the dough from the guillotine cutter and is in direct contact with the die face to insure accurate cutting. Each of these methods suffered from deficiencies including, but not limited to, deformation, extra handling steps and procedures, increased floor space for production equipment, or the like.

However, there is a continual need for increased throughput of the food substance and which better fulfills the concerns of food production.

### SUMMARY

This need and other problems in the field of food production are solved by the present invention, in a preferred aspect, by orientating the die face of an extrusion die at an acute angle to the horizontal and in the most preferred form to a conveyance direction and by cutting individual pieces from the extrudate after exiting the die face and prior to its receipt on a takeaway device such that the cut individual pieces tend to move away from the cutting mechanism under gravitational and ultrasonic forces, without touching the die face, and without deformation.

In other preferred aspects, the cutting mechanism according to the preferred teachings of the present invention is an ultrasonically vibrating knife oriented at a minor acute angle from the die face as it moves in a cutting path parallel to but without physical contact with the die face.

In still other preferred aspects, the cutting mechanism according to the preferred teachings of the present invention moves in a return path from the completion to the initiation of the cutting path in directions parallel as well as perpendicular to the extrudate direction allowing continuous extruding of the extrudate for the next cutting cycle.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of an apparatus according to the preferred teachings of the present invention.

FIGS. 2-5 show diagrammatic side views of the apparatus of FIG. 1 illustrating movement of the cutting mechanism.

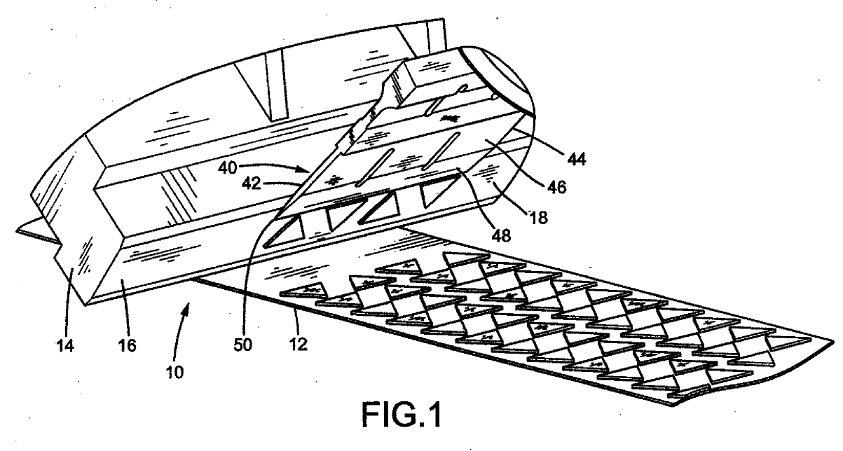

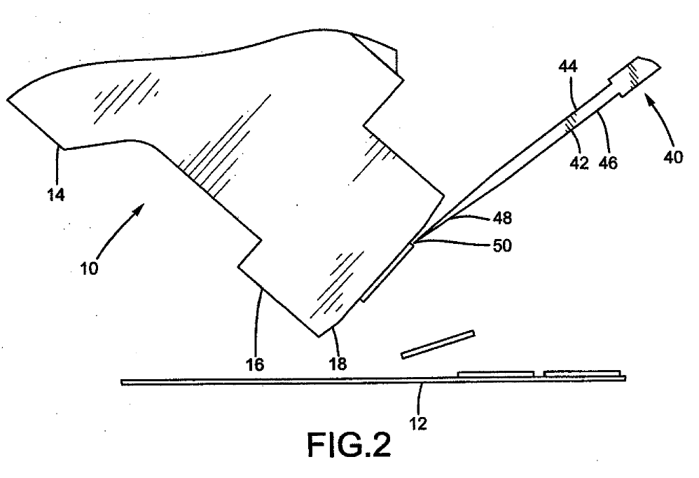

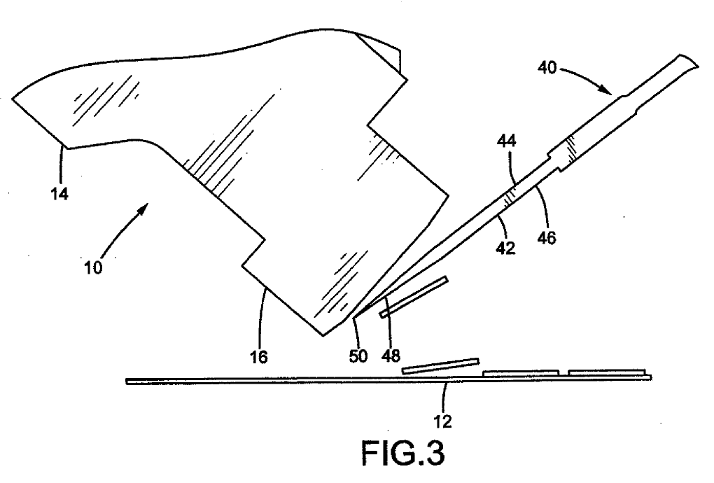

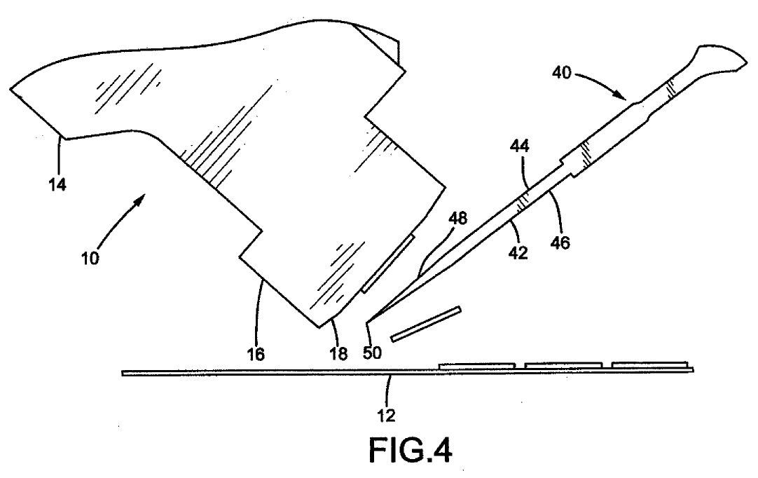

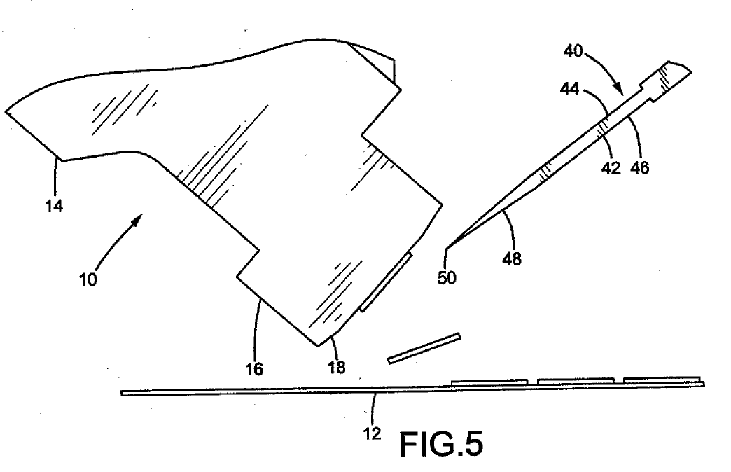

All figures are drawn for ease of explanation of the basic teachings of the present invention only; the extensions of the Figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “top”, “bottom”, “first”, “second”, “side”, “end”, “outside”, “upper”, “lower”, “front”, “rear”, “back”, and similar terms are used herein, it should be understood that these terms have reference only to the structure shown in the drawings as it would appear to a person viewing the drawings and are utilized only to facilitate describing the preferred embodiments.

### DESCRIPTION OF THE PREFERRED EMBODIMENTS

Apparatus utilizing methods for producing a food product according to the preferred teachings of the present invention is shown in the drawings and generally designated 10. In particular, apparatus 10 includes a takeaway device shown in a most preferred form as a conveyance mechanism 12 for moving food products in a conveyance direction. Conveyance mechanism 12 can be of any desired form including, but not limited to, of conventional forms. In one preferred form, conveyance mechanism 12 could be a conventional conveyor including a continuous support surface such as, but not limited to, in the form of a belt traveling in a circuitous path and upon which the food product is directly supported. In other preferred forms, conveyance mechanism 12 conveys an intermediate member upon which the food product is supported Such an intermediate member could be a transport medium which is not edible and which could be utilized as part of the packaging for the food product including but not limited to trays or cartons, support boards or paper for the food product and/or which could be utilized as part of further processing of the food product. Likewise, the transport medium could be in the form of an edible substance. As an example, conveyance mechanism 12 could be a flighted conveyor between which the transport medium is releasably positioned. In general, any manner of receiving and transporting the food product which minimizes handling and deformation of the food product can be utilized for conveyance mechanism 12 according to the teachings of the present invention.

Apparatus 10 according to the teachings of the present invention includes an extruder 14 for extruding a food substance in the form of an extrudate out of an extrusion die 16. In the most preferred form, extrusion die 16 is formed of anti-stick plastic material which does not need lubrication such as DELRIN® which is a brand name for an acetal polyoxymethylene resin owned by DuPont. It is a hard resin approved for food handling use by the FDA. It is an economical material with properties of good strength, light weight, and self-lubrication. It is commonly used in the food industry. In particular, die 16 includes a die face 18 which is generally perpendicular to the movement direction of the extrudate out of the extrusion die 16. The opening in the extrusion die 16 can be of any desired shape representing an item of interest including any identifiable object such as a geometric shape, animal, plant, structure, trademark, or the like that imparts a desired outline to the periphery of the food piece. Extruder 14 and extrusion die 16 can be of any desired form including, but not limited to, conventional forms. In preferred forms, extruder 14 and extrusion die 16 can be, but not limited to, of the types shown and/or described in U.S. Pat. Nos. 5,620,713 and 6,561,235. However, extruder 14 and extrusion die 16 can be of a variety of forms and types according to the teachings of the present invention.

Similarly, extruder 14 according to the preferred teachings of the present invention could produce a single homogenous food substance for extrusion out of extrusion die 16 or could produce one or more food substances for extrusion out of extrusion die 16 in a pattern of a continuous or discontinuous form and/or in a repeatable or random type. The shape, arrangement, and like characteristics of the extrudate can vary according to the selection and type of extruder 14 and extrusion die 16 according to the preferred teachings of the present invention.

Additionally, the food substance being extruded from extruder 14 and extrusion die 16 can take a variety of forms according to the teachings of the present invention. However, of special concern are food substances which change in shape with the slightest touch at ambient temperatures. Of even further concern are food substances having a stickiness which would adhere to a conventional metal knife if cut thereby, such that use of rotary die cutters is not a viable option. In one preferred form, the food substance could be in the form of confectionary materials, dough, such as cookie dough, or cereal. However, apparatus 10 according to the teachings of the present invention can have application to other food substances including, but not limited to, fruit snacks such as gummy bears, marshmallows, ice cream, at least partially solidified or gelled yogurt, cheese, candy and like food substances which are flowable and/or easily deformable as an extrudate and sticky and which are preferred to have a molded shape with relatively flat, parallel upper and lower surfaces.

According to the teachings of the present invention, the extrusion die 16 is arranged relative to the conveyance mechanism 12 such that the extrudate direction of the extrudate out the extension die 16 is at an obtuse angle relative to the conveyance direction and that die face 18 is at an acute angle relative to the conveyance direction. In the most preferred form, the acute angle of the die face 18 is in the range of 15 to 80 degrees and in the most preferred form is in the order of 45 degrees.

Apparatus 10 further includes a cutting mechanism 40 for cutting the extrudate exiting the extrusion die 16. According to preferred teachings of the present invention, cutting mechanism 40 is in the form of a titanium knife 42 which is ultrasonically vibrated at least during the cutting process. In particular, knife 42 of the preferred form includes an ultrasonic cutting blade 44 having upstream and downstream faces 46 extending generally perpendicular to the extrudate direction and terminating in wedge shaped cutting faces 48 and in turn terminating in a cutting edge 50. Titanium knife 42 and its ultrasonic vibration can be of a variety of forms including, but not limited to, of conventional forms.

One skilled in the art of ultrasonic cutting is highly aware that ultrasonic cutting blade 44 cannot come in contact with anything nondeformable, especially items fabricated out of metal, or ultrasonic cutting blade 44 will shatter immediately. Further, utilizing ultrasonic cutting blade 44, there is no ability to land on a cutting surface, again because the ultrasonic cutting blade 44 will shatter if touched by a hard, nondeformable material. Thus, the cutting action of ultrasonic cutting blade 44 does not touch the die face 18, but also does not land on or otherwise contact a hard cutting platform such as, but not limited to, conveyance mechanism 12 or other forms of takeaway device. The cutting procedure is done without support to the extrudate, i.e. in mid-air.

Specifically, cutting mechanism 40 according to the preferred teachings of the present invention is movable along a cutting path towards the conveyance mechanism 12 and extending parallel to but without physical contact with the die face 18 of extrusion die 16, and in very close proximity to the die face 18, but never in actual contact. The ultrasonic energy of the ultrasonic cutting blade 44 is enough to sever the individual pieces from the extrudate. Ultrasonic cutting blade 44 never approaches the die face 18 closer than 0.1 mm to insure safety of apparatus 10 and is not spaced more than 0.3 mm according to the teachings of the present invention. At the completion of cutting path, cutting mechanism 40 moves in a return path in the extrudate direction away from the die face 18 and moves away from the conveyance mechanism 12 back to the cutting path. In a preferred form, movement in the extrudate direction and away from the conveyance mechanism 12 can occur at least initially simultaneously such that cutting edge 50 moves along an arcuate path depending upon the relative speed in the extrudate direction and away from the die face 18. However, it can be appreciated that movement of the cutting mechanism 40 can occur at least initially solely in the extrudate direction. Likewise, the cutting mechanism 40 in the return path at a sufficient spacing from the conveyance mechanism 12 can move to the initiation of the cutting path in the extrudate direction towards the die face 18. In the preferred form, movement in the extrudate direction towards the die face 18 occurs at least simultaneously with movement away from the conveyance mechanism 12 such that cutting edge 50 moves along an arcuate path depending upon the relative speed of the extrudate out of the die face 18. It can be appreciated that movement of the cutting mechanism 40 can occur solely opposite to the extrudate direction. However, it can be appreciated that movement of the cutting mechanism 40 in the cutting path can occur while moving toward or away from the conveyance mechanism 12 according to the teachings of the present invention,

According to the preferred teachings of the present invention, knife 42 is arranged with cutting edge 50 closely adjacent to die face 18 in the cutting path of the cutting mechanism but with faces 46 and 48 at a non-parallel, acute angle relative to die face 18. In the preferred form, faces 46 and 48 extend at an acute angle in the range of 2 to 45 degrees, preferably in the range of 5 to 22 degrees and in the most preferred form in the order of 7 degrees. In the most preferred form, the speed of the extrudate in the extrudate direction is generally equal to 5-12% of the speed of the cutting edge 50 parallel to the die face 18.

Now that the basic construction of apparatus 10 according to the preferred teachings of the present invention has been explained, a preferred method and some of the advantages thereof according to the teachings of the present invention can be set forth. For purposes of explanation, it will be assumed that cutting mechanism 40 is at the initiation of the cutting path, extrudate is being extruded from extrusion die 16, and conveyance mechanism 12 is moving in the conveyance direction. Specifically, assuming a desired length of extrudate has been extruded beyond die face 18, knife 42 is moved in the cutting path with cutting edge 50 moving along but without physical contact with die face 18. It should be appreciated that forming extrusion die 16 from material such as DELRIN® results in several advantages including reduced damage in the event that knife 42 unintentionally comes in contact with die 16. Further, it should be appreciated that due to the acute angle of die face 18 relative to conveyance mechanism 12, the upper leading edge of the extrudate will tend to lean away from the downstream faces 46 and 48 of knife 42 as knife 42 cuts into the extrudate due to ultrasonic vibration such that extrudate does not tend to stick to the downstream faces 46 and 48. Additionally, it should be appreciated that due to the acute angle of knife 42 relative to die face 18, extrudate does not tend to bind between the upstream faces 46 and 48 of knife 42 and die face 18 even though extrudate is being continuously extruded for extrusion die 16 as knife 42 moves along the cutting path.

It should be appreciated that when knife 42 reaches or is slightly before the end of cutting path, cutting edge 50 has passed through the extrudate such that an individual piece has been cut from the extrudate, but knife 42 does not contact or otherwise land on the conveyance mechanism 12. It should be appreciated that the die face 18 is spaced from conveyance mechanism 12 according to the teachings of the present invention such that the downstream face of the individual piece lands flatly on the conveyance mechanism 12. In this regard, landing flatly on the conveyance mechanism 12 reduces the possibility of individual piece deformation that can occur if the individual piece should land with any portion of the peripheral edge abutting with conveyance mechanism 12. The principle advantage resides in the minimization of any deformation of the item's pattern or appearance whether the external peripheral shape or any internal pattern or design by minimizing contact with the ultrasonically activated knife 42 as the individual pieces, cut in mid-air, fall away by gravity as the knife 42 moves in its cutting direction.

After completing its cutting path, the cutting mechanism 40 moves in its return path back to the cutting path. It should be noted that movement in the extrudate direction insures that cutting mechanism 40 does not interfere with the continuous extruding of the extrudate exiting the extrusion die 16 while the cutting mechanism 40 is in the return path. Further, due to movement in the conveyance in the conveyance direction, individual pieces on the conveyance mechanism 12 are moved to be in a non-interfering position to the receipt of the next slug cut from the extrudate. Relating conveying speed to the cutting speed of knife 42 and to the cross sectional geometry of the individual pieces, cut individual pieces can be individually directed or dropped without interference or overlap onto a moving surface which can be comprised of an intermediate member such as a packaging tray or flat while minimizing spacing in the conveyance direction. The benefit of direct packaging is that the individual pieces do not have to be handled in any additional way, eliminating additional deformation issues. When the cutting mechanism 40 reaches the initiation of the cutting path, operation can be repeated according to the preferred teachings of the present invention. In the most preferred form, cutting mechanism 40 moves in its cutting path about 300 times per minute.

Extrusion die 16 can include one or more openings spaced in a direction perpendicular to the conveyance direction according to the teachings of the present invention. As an example, individual pieces in the form of an organized array of multiple rows and multiple columns could be produced and laid out on a packaging tray or flat or like intermediate member, utilizing the methods and apparatus 10 according to the teachings of the present invention.

Now that the basic teachings of the present invention have been explained, many extensions and variations will be obvious to one having ordinary skill in the art. For example, although the takeaway device has been described as conveyance mechanism 12 of the preferred form shown and which is believed to produce synergistic results in maintaining individual pieces in non-interfering arrangements, apparatus 10 and methods according to the teachings of the present invention may produce other advantages in applications where interference is not a concern including, but not limited to, placement in bins, cartons, or even bags, with the takeaway device in such applications being of any desire form adapted to receive the cut individual pieces including, but not limited to, funnels.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Method for producing a deformable food product comprising:
extruding an extrudate of a food substance out an extrusion die in an extrudate direction with the extrusion die having a die face perpendicular to the extrudate direction; and
while the extrudate is being extruded, moving an ultrasonically vibrating knife in a cutting path from an initiation with a cutting edge above the extrudate to a completion with the cutting edge below the extrudate and adjacent and parallel to and without physical contact with the die face with a knife face of the knife extending at a minor acute angle between 2-45° relative to the die face to cut an individual piece from the extrudate and then moving the ultrasonically vibrating knife in a return path from the completion to the initiation.

2. The method of claim 1 with moving the ultrasonically vibrating knife in the return path including moving the ultrasonically vibrating knife in the extrudate direction away from the die face after reaching the completion, and in the extrudate direction toward the die face before the initiation, and perpendicular to the extrudate direction between the completion and the initiation.

3. The method of claim 2 with moving the ultrasonically vibrating knife comprising simultaneously moving the ultrasonically vibrating knife parallel and perpendicular to the extrudate direction away from the die face; and simultaneously moving the ultrasonically vibrating knife parallel and perpendicular to the extrudate direction toward the die face.

4. The method of claim 3 with extruding the extrudate comprising extruding the extrudate in the extrudate direction at a major obtuse angle in the order of 120-180° to horizontal.

5. The method of claim 4 further comprising:
directly depositing cut individual pieces into packaging being conveyed away from the extrusion die, with moving the ultrasonically vibrating knife comprising moving the ultrasonic cutting blade without physical contact with the packaging and without physical contact of the individual piece with the packaging before being completely cut from the extrudate.

6. The method of claim 5 with moving the ultrasonically vibrating knife including ultrasonically vibrating a titanium knife.

7. Method for producing a food product comprising:
extruding an extrudate of a deformable food substance out an extrusion die in an extrudate direction;
moving an ultrasonic cutting mechanism to cut an individual piece from the extrudate; and
receiving the cut individual piece in a takeaway device, with moving the ultrasonic cutting mechanism including moving the ultrasonic cutting mechanism after the extrudate of the deformable food substance is extruded out of the extrusion die and prior to the extrudate of the deformable food contacting the takeaway device, with the ultrasonic cutting mechanism being adjacent to but without making direct contact with the extrusion die.

8. The method of claim 7 with the extrusion die having a die face perpendicular to the extrudate direction, with moving the cutting mechanism comprising moving the cutting mechanism in a cutting path adjacent and parallel to but without physical contact with the die face.

9. The method of claim 8 with moving the cutting mechanism in the cutting path occurring while the extrudate is being extruded and between an initiation above the extrudate and a completion below the extrudate and above the takeaway device and including moving the cutting mechanism in a return path from the completion to the initiation.

10. The method of claim 9 with moving the cutting mechanism in the return path including moving the cutting mechanism in the extrudate direction away from the die face after reaching the completion, and in the extrudate direction toward the die face before the initiation, and perpendicular to the extrudate direction between the completion and the initiation.

11. The method of claim 10 with moving the cutting mechanism comprising simultaneously moving the cutting mechanism parallel and perpendicular to the extrudate direction away from the die face; and simultaneously moving the cutting mechanism parallel and perpendicular to the extrudate direction toward the die face.

12. The method of claim 11 with receiving the cut individual pieces comprising depositing the individual piece cut from the extrudate onto a package tray or flat being conveyed in a conveying direction, with extruding the extrudate comprising extruding the extrudate in the extrudate direction in the order of 120-180° to the conveying direction, with moving the ultrasonic cutting mechanism comprising moving the ultrasonic cutting mechanism without physical contact with the package tray or flat and without the individual piece contacting the package tray or flat before being completely cut from the extrudate.

13. Apparatus for producing a food product comprising, in combination:
an extrusion die including a die face having an extrudate opening through which an extrudate extrudes in an extrudate direction, with the die face being perpendicular to the extrudate direction; and
an ultrasonically vibrating knife moveable in a cutting path from an initiation with a cutting edge above the extrudate to a completion with the cutting edge below the extrudate and parallel to the die face with a knife face of the knife extending at a minor acute angle between 2-45° relative to the die face to cut a slug from the extrudate, with the ultrasonically vibrating knife moveable in a return path from the completion to the initiation.

14. The apparatus of claim 13 with the return path extending parallel to the extrudate direction away from the die face adjacent to the completion and toward the die face adjacent to the initiation and extending perpendicular to the extrudate direction spaced from the die face between the completion and the initiation.

15. The apparatus of claim 14 wherein the return path includes a portion simultaneously extending parallel and perpendicular to the extrudate direction adjacent to the completion and a portion simultaneously extending parallel and perpendicular to the extrudate direction adjacent to the initiation.

16. The apparatus of claim 15 further comprising, in combination:
a conveyance mechanism extending in a conveyance direction, with the die face being at an acute angle in the order of 0-60° to the conveyance direction, with the ultrasonically vibrating knife in the cutting path being spaced from and without physical contact with the conveyance mechanism.

17. The apparatus of claim 16 with the ultrasonically vibrating knife comprising a titanium knife, and with the extrusion die being formed of an anti-slide plastic material.

18. Apparatus for producing a food product comprising, in combination:
an extrusion die including a die face having an extrudate opening through which an extrudate extrudes in an extrudate direction, with the die face being perpendicular to the extrudate direction;
a cutting mechanism; and
a takeaway device receiving cut individual pieces of the extrudate, with the cutting mechanism moveable in a cutting path not in contact with and spaced from the die face and the takeaway device.

19. The apparatus of claim 17 with the cutting path including an initiation above the extrudate opening and a completion below the extrudate opening, with the cutting mechanism moveable in a return path from the completion to the initiation.

20. The apparatus of claim 19 with the return path extending parallel to the extrudate direction away from the die face adjacent to the completion and toward the die face adjacent to the initiation and extending perpendicular to the extrudate direction spaced from the die face between the completion and the initiation.
